(19) United States
(12) Patent Application Publication
(10) Pub. No.: US 2002/0101980 A1
(43) Pub. Date: Aug. 1, 2002

(54) Protection of subscriber line interface circuits (SLICS) without degradation in longitudinal balance

(76) Inventors: Mark Ayoub, Aylmer,Quebec (CA); Joe Cy Lung, Ottawa,Ontario (CA)

Correspondence Address: MARKS & CLERK, P.O. BOX 957, STATION B, OTTAWA, ON, K1P 5S7, CA

(21) Appl. No.: 09/770,610

(22) Filed: Jan. 29, 2001

(51) Int. Cl. H04M 1/00; H04M 9/00

(52) U.S. Cl. 379/399.01

(57) ABSTRACT

A subscriber line interface circuit has first and second line drivers for connection to respective tip and ring lines of a subscriber loop. Each of said line drivers is in a feedback loop. A current limiting device is included in each feedback loop for providing protection against excessive current. In this way the effective impedance of the current limiting devices is small relative to their actual impedance and as a result any impedance mismatch between the current limiting devices has a negligible effect on the longitudinal balance of the subscriber loop.

### BACKGROUND OF THE INVENTION

1. Field of the Invention

This invention disclosure describes a method and apparatus for protecting subscriber line interface circuits in telecommunication systems without degradation in longitudinal balance.

2. Brief Description of the Prior Art

In typical telecommunication systems, telecom line cards are connected to subscriber equipment by a pair of wires called tip 100 and ring 101 lines. These lines are highly susceptible to electrical overstresses and network hazards, which cause telecom line card to be subjected to high levels of overcurrents and overvoltages. A major source of electrical overstress that can occur in telecommunication systems is due to lightning surges, which may directly strike a telecom line. Another major source of electrical overstress is due to power cross surges that occur when fallen live AC power lines come in direct contact with a telecom line since very often telecom lines are strung on the same poles as power distribution lines. These hazardous conditions pose a serious threat to line cards deployed at the central office and in remote switching locations. To minimize the threat of damage, and potential cost and downtime associated with equipment failure, adequate levels of protection must be designed at the line card interface to ensure reliable operation and regulatory compliance. Telecom lines are also susceptible to noise induction due to their close proximity to power lines and other sources of interference. The primary sources of noise are 60/50 Hz power lines, cable cross talk, and radio frequency (RF) transmissions. These noise sources induce longitudinal currents to flow in the line. One of the functions of a SLIC is to distinguish between these longitudinal noise signals and the transversal signals, and reject the unwanted longitudinal components. This is a measure of the SLIC's longitudinal balance. Longitudinal balance is a measure of how closely the impedances from the tip lead to ground and the ring lead to ground are matched. Higher values of balance indicate better matching of the tip-ground and ring-ground impedances, and result in better longitudinal noise rejection. Any event that causes an impedance imbalance in the line will degrade the SLIC's longitudinal balance.

FIG. 1 is a simplified model of a conventional subscriber loop driven by a SLIC with protection devices connected. To protect against overvoltage conditions, overvoltage protection 104 is installed in parallel with the SLIC to switch rapidly from a high impedance state to a low impedance state in response to an overvoltage condition. In normal operation, overvoltage protection devices do not interfere with regular telephone service. To protect against overcurrent conditions, overcurrent protection devices 102, 103 are installed in series with the SLIC to interrupt the flow of current by switching from a low impedance state to a high impedance state in response to an overcurrent condition.

A typical example of an overcurrent protection device that is widely used is a PTC (positive temperature coefficient). Generally, the PTC has a resistance that is much less than the remainder of the circuit, and has little influence on the normal operation of the circuit. In response to an overcurrent condition, the PTC's temperature will rise causing its resistance to rapidly increases (i.e. trips), reducing the current in the circuit to a safe value, and therefore protecting SLIC from sustaining permanent damage. The PTC will reset and revert back to a low impedance state once its temperature decreases to a value below its tripping value.

The voltage clamping devices VCD 105, 106 are used to prevent the SLIC 120 from being exposed to voltages in excess of its design limits. In normal operation, the voltage clamping devices allow voltages up to the designed clamping level to pass through. If a voltage outside the clamping level appears at the VCD terminals, the VCD will remain at the clamping voltage, and switch to a low impedance to divert the fault current away from the SLIC. A typical example of a VCD is a diode damper as shown in FIG. 2. The clamping levels in FIG. 2 are the central office battery voltage (typically −48 volts) and ground. A good longitudinal balance requires very close matching of the impedances from the tip 100 to ground and the ring 101 to ground. Since both tip and ring are connected in series with current limiting devices 102, 103, it is important that these current limiting devices are very well matched to each other. When current limiting devices such as PTCs are first installed, the manufacturer can guarantee that they are closely matched to each other to within a certain tolerance and good longitudinal balance can be achieved. When an overcurrent fault occurs, the PTC will quickly trip and change from a low impedance state to a high impedance state, thereby reducing the flow of current and protecting the SLIC. After the trip event and the PTC resets, the PTC will revert back to a low impedance state. However, the PTC's post-trip impedance Z₂ will be greater than it's original impedance Z₁ up to a maximum impedance Zₘₐₓ (see FIG. 3.)

Z₁<Z₂<=Zₘₐₓ (1)

The fact that the post-trip impedance of the tip side PTC is not necessarily the same as the post-trip impedance of the ring side PTC creates a problem. This mismatch in impedances will cause an imbalance between the tip to ground impedance and the ring to ground impedance and therefore have a negative impact on the longitudinal balance of the system during normal use.

### SUMMARY OF THE INVENTION

The present invention offers a simple, yet effective, solution to the problem of protecting line cards without a degradation in longitudinal balance after the occurrence of an electrical overstress on the line.

In accordance with the invention the PTCs are placed within the feedback loop of the tip and ring line drivers. This reduces the sensitivity of the longitudinal balance to any mismatch in PTC impedances. This is accomplished by using the large loop gain of the tip and ring line drivers to minimize the impedance of the PTCs and thus any mismatch between the 2 PTCs will be even smaller.

Accordingly the present invention provides a subscriber line interface circuit, comprising first and second line drivers for connection to respective tip and ring lines of a subscriber loop, a feedback loop for each of said line drivers, and a current limiting device included in each said feedback loop for providing protection against excessive current, whereby the effective impedance of said current limiting devices is small relative to its actual impedance so that any impedance mismatch between said current limiting devices has a negligible effect on the longitudinal balance of the subscriber loop.

The current limiting devices are typically positive temperature coefficient devices, preferably in series with voltage clamping devices.

The invention thus provides a method of protecting SLICs and line cards from electrical overstresses and network hazards without degradation in longitudinal balance once the line fault is removed. In particular, it can reduce the impact of current limiting device impedance mismatch on the longitudinal balance of the SLIC in a communication system providing, but not limited to, voice, data, and DSL transmissions.

The invention can also provide a means of coping with the continuous changing of the mismatches of the current limiting device due to, but not limited to, multiple tripping, humidity, temperature and aging in maintaining good longitudinal balance.

### BRIEF DESCRIPTION OF THE DRAWINGS

The invention will now be described in more detail, by way of example, only with reference to the accompanying drawings, in which:

FIG. 1 shows a prior art protection scheme for a central office end of a subscriber loop;

FIG. 2 shows a typical prior art voltage clamping device;

FIG. 3 shows the typical operating curve of a PTC device;

FIG. 4 is a block diagram of a circuit in accordance with one embodiment of the invention.

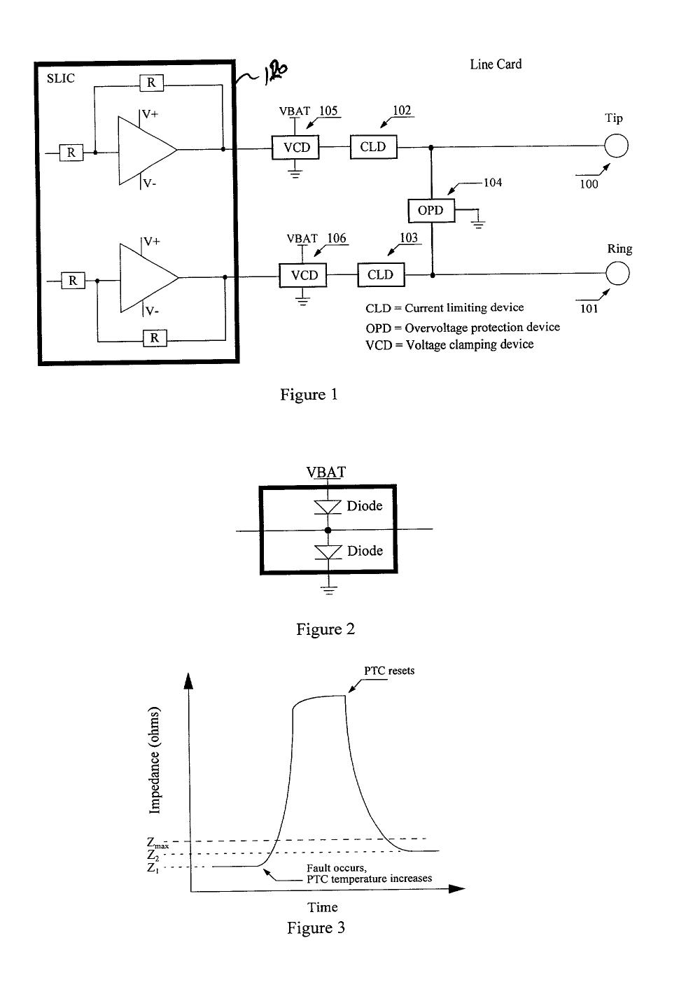

### DETAILED DESCRIPTION OF THE PREFERRED EMBODIMENTS

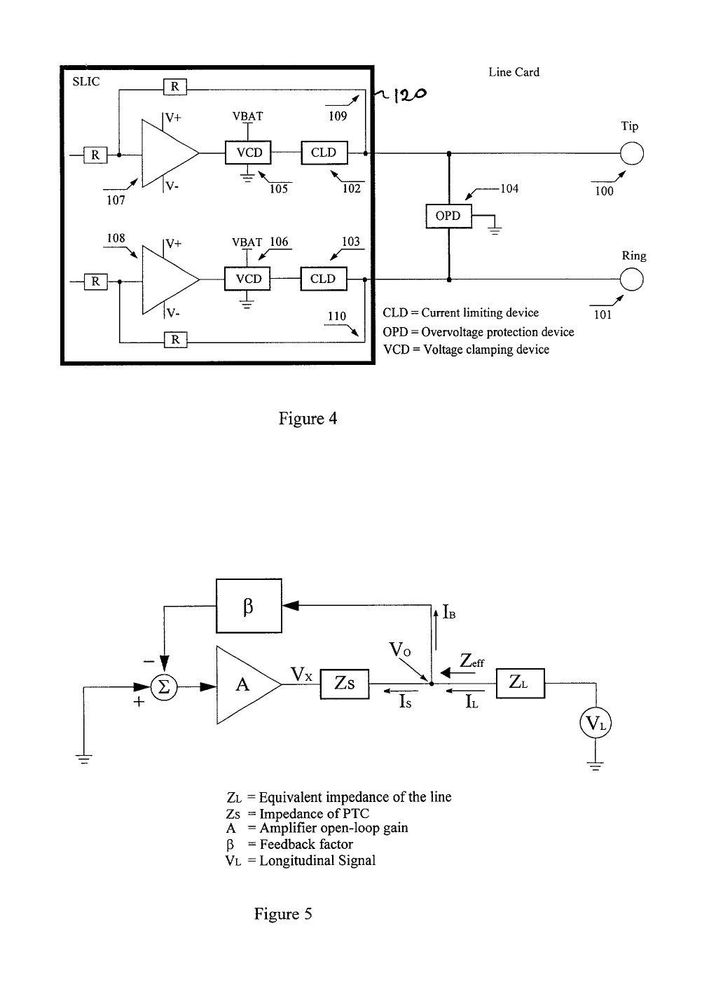

The circuit shown in FIG. 4 differs from FIG. 1 that the current limiting devices 102, 103 and voltage clamping devices 105, 106 are included in the feedback loops 109, 110 of the SLIC. The voltage clamping devices VCD 105, 106 serve two purposes. Firstly, the voltage clamping device 105, 106 will only allow voltages up to the designed clamping level to pass; in this case voltages between the central office battery voltage and ground. This will prevent the line drivers 107, 108 from being exposed to voltages in excess of their design maximums. Secondly, since most modern SLICs provide some measure of current limiting that is usually set at a lower current value than the tripping current of the PTC, the voltage clamping device will have to be able to go into a low impedance state in the presence of overvoltage. This will effectively shunt all of the fault current away from the SLIC as well as provide the necessary current needed to trip the PTC 102, 103. Without the voltage clamping device becoming very low impedance and drawing a large current, the PTC might never trip and would not protect the SLIC.

FIG. 5 shows the general structure of a feedback amplifier driving a load. This will be used as a representation of the tip and ring line driver interfacing the line. The effective impedance Z_{eff} looking into the feedback system from the line will be very small for any given impedance of Z_{S} (impedance of a PTC.) From FIG. 5, it will be seen that

I_{L}=I_{S}+I_{B}

Where I_{L} is the load current, I_{S} is the current through the driver amplifier, and I_{β} is the current through the feedback circuit. Since the impedance of the β path is over 1000 times larger then the impedance of the Z_{S} path, then I_{S}>>I_{β} and therefore:

I_{L}≅I_{S} (2)

From Equation 2, solving for the voltage Vₒ gives:

Vₒ=V_{L}*Z_{S}/(Z_{S}+Z_{L})+Vₓ*Z_{L}/(Z_{S}+Z_{L}) (3)

From the feedback loop, solving for Vₓ gives:

Vₓ=−Vₒ*A*b (4)

Combining Equations 3 and 4 and solving for Vₒ gives:

V_{O}=V_{L}*Z_{S}/(Z_{S}+Z_{L}+A*b*Z_{L}) (5)

Using nodal voltage analysis to solve for I_{L} gives:

I_{L}=(V_{L}−V_{O})/Z_{L} (6)

Substituting Equation 6 into Equation 5 gives:

I_{L}=(Z_{L}+A*β*Z_{L})/(Z_{S}+Z_{L}+A*b*Z_{L})*V_{O}/Z_{L} (7)

Now the effective impedance Z_{eff} can be solved from Equation 5 and Equation 7 since:

Z_{eff}=V_{O}/I_{L}

which can be reduced to:

Z_{eff}=Z_{S}*Z_{L}/(Z_{L}+A*b*Z_{L}) (8)

Since the amplifier open-loop gain A is large, A>>1, then from Equation 8 it follows that:

Z_{eff}≅Z_{S}/A*β (9)

In a typical line card application, common values of Z_{S}, A and β would be 25 ohms, 1000, and 0.5 respectively. These values result in a Z_{eff} value of 0.05 ohms. Thus it can be seen that the present invention provides a unique method of making any mismatches in the impedance of the PTCs virtually negligible in determining the longitudinal balance of the line. The present invention comprises a simple, inexpensive, yet effective, solution for protecting SLICs without degradation in longitudinal balance after a fault condition.

We claim:

1. A subscriber line interface circuit, comprising first and second line drivers for connection to respective tip and ring lines of a subscriber loop, a feedback loop for each of said line drivers, and a current limiting device included in each said feedback loop for providing protection against excessive current, whereby the effective impedance of said current limiting devices is small relative to their actual impedance so that any impedance mismatch between said current limiting devices has a negligible effect on the longitudinal balance of the subscriber loop.

2. A subscriber line interface circuit as claimed in claim 1, wherein each said current limiting device is a positive temperature coefficient (PTC) device.

3. A subscriber line interface circuit as claimed in claim 1, wherein in each feedback loop said current limiting device is in series with a voltage clamping device.

4. A subscriber line interface circuit as claimed in claim 3, wherein said voltage clamping device is a diode clamper.

5. A subscriber line interface circuit as claimed in claim 4, wherein said diode clamper comprises a pair of diodes in series.

6. A subscriber line interface circuit as claimed in claim 4, further comprising an overvoltage protection device outside said feeback loops for connection between said tip and ring lines.

7. A subscriber line interface circuit as claimed in claim 1, wherein each said current limiting device has an effective impedance Z_{eff}≅Z_{S}/A*β, wherein Z_{S} is the actual impedance of the current limiting device, A is the gain of the associated line driver, and β is the feedback factor.

8. A method of protecting a subscriber line interface circuit without degradation in longitudinal balance of a subscriber loop, said subscriber line interface circuit comprising a pair of line drivers for connection to tip and ring lines of said subscriber loop, said line drivers being included in respective feedback loops, comprising placing respective current limiting devices in said feedback loops so as to reduce their effective impedance to the tip and ring lines.

9 A method as claimed in claim 8, wherein said current limiting devices are positive temperature coefficient devices.

10. A method as claimed in claim 8, further comprising placing a voltage clamping device in series with each current limiting device in its respective feedback loop.

11. A method as claimed in claim 10, wherein said voltage clamping devices go into a low impedance state in the presence of an overvoltage and shunt current away from the associated line driver.

12. A method as claimed in claim 11, wherein said shunt current trips the series-connected current limiting device.

13. A method as claimed in claim 8, wherein said current limiting device has an effective impedance Z_{eff}≅Z_{S}/A*β, wherein Z_{S} is the actual impedance of the current limiting device, A is the gain of the associated line driver, and β is the feedback factor.

14. A method as claimed in claim 13, wherein Z_{S}, A, and β, are respectively about 25 ohms, 1000 ohms, and 0.5.

15. A method as claimed in claim 8, wherein said voltage clamping devices only allow voltages up to a predetermined clamping level to pass.

16. A method as claimed in claim 15, wherein said clamping devices only allow voltages between a central office battery voltage and ground to pass.
